(19) United States
(12) Patent Application Publication
(10) Pub. No.: US 2016/0279468 A1
(43) Pub. Date: Sep. 29, 2016

(54) Feedback Device Capable of Easily Adjusting Loaded Force for Sphincter Contracting Exercise

(71) Applicant: Chien-Hsiung Hung, New Taipei City (TW)

(72) Inventor: Chien-Hsiung Hung, New Taipei City (TW)

(21) Appl. No.: 14/670,430

(22) Filed: Mar. 27, 2015

(51) Int. Cl. A63B 23/20; A63B 24/00; A61H 1/02

(52) U.S. Cl. CPC A63B 23/20; A61H 1/02; A63B 24/0087; A61H 2201/5097

(57) ABSTRACT

A feedback device capable of easily adjusting loaded force for sphincter contracting exercise includes an outer enclosure, an outer cover, a mechatronic assembly and an electric conductive device; the electric conductive device includes a plurality of electric conductive sheets and the surface thereof is installed with a central column having a plurality of bumps. Through rotating the central column, the electric conductive sheets are enabled to perform a lever movement corresponding to the bumps (served as pivots) at different locations, thereby allowing different lever impedance value to be generated due to different pivot.

### SUMMARY OF THE INVENTION

One primary objective of the present invention is to provide a feedback device capable of easily adjusting loaded force for sphincter contracting exercise (abbreviated as a feedback device) which overcomes the disadvantage of a conventional auxiliary device being inconvenient when the auxiliary component is required to be replaced. The feedback device provided by the present invention allows a user to directly adjust the feedback device for achieve the objective of altering impedance. Thus, the operation of replacing auxiliary component is not required, and the possibility of damaging the internal structure is decreased, thereby allowing the feedback device of the present invention to be more durable and have a longer service life.

For achieving the above-mentioned objective, one technical solution provided by the present invention is to provide a feedback device capable of easily adjusting loaded force for sphincter contracting exercise which includes: an outer enclosure having elasticity; an outer cover capable of being stably connected to the outer enclosure; a mechatronic assembly disposed in the outer enclosure and the outer cover; and an electric conductive device disposed in the outer enclosure and the outer cover.

The electric conductive device is characterized in: the electric conductive device includes a plurality of electric conductive sheets and a central column, wherein one end of each of the electric conductive sheets is electrically connected to the mechatronic assembly, and the other end defined as a free end is extended into the interior of the outer enclosure; one end of the central column is connected to the mechatronic assembly with a rotary means, and the other end thereof is extended into the interior of the outer enclosure and electrically connected to the mechatronic assembly, the outer surface of the central column is formed with a plurality of bumps, and the locations of the plural bumps are able to be altered when the central column is rotated.

The plural electric conductive sheets are able to respectively perform a lever movement with the bumps served as a pivot, and the free ends of the electric conductive sheets are able to selectively contact the other end of the central column thereby enabling the mechatronic assembly to be selectively conducted for operation.

The above-mentioned mechatronic assembly includes a vibration motor, lighting units and a wireless signal transceiver, and a control circuit system is used for controlling.

### BRIEF DESCRIPTION OF THE DRAWINGS

FIG. 1 is a partial cross sectional view showing the feedback device capable of easily adjusting loaded force for sphincter contracting exercise according to one preferred embodiment of the present invention;

FIG. 1A is a schematic view showing one of the applicable structures in the interior of the outer enclosure according to the present invention;

FIG. 2A is a perspective exploded view showing the feedback device capable of easily adjusting loaded force for sphincter contracting exercise according to the present invention;

FIG. 2B is a block diagram showing the mechatronic assembly according to the present invention;

FIG. 3A to FIG. 3D are schematic views showing different statuses of the electric conductive sheet according to the present invention;

FIG. 4 is another cross sectional view based on the cross section shown in FIG. 1;

FIG. 5A to FIG. 5D are schematic views showing different training impedance adjusting modes of the feedback device according to the present invention; and

FIG. 6 is a schematic view showing the feedback device working with a computing device according to the present invention.

### DETAILED DESCRIPTION OF THE PREFERRED EMBODIMENT

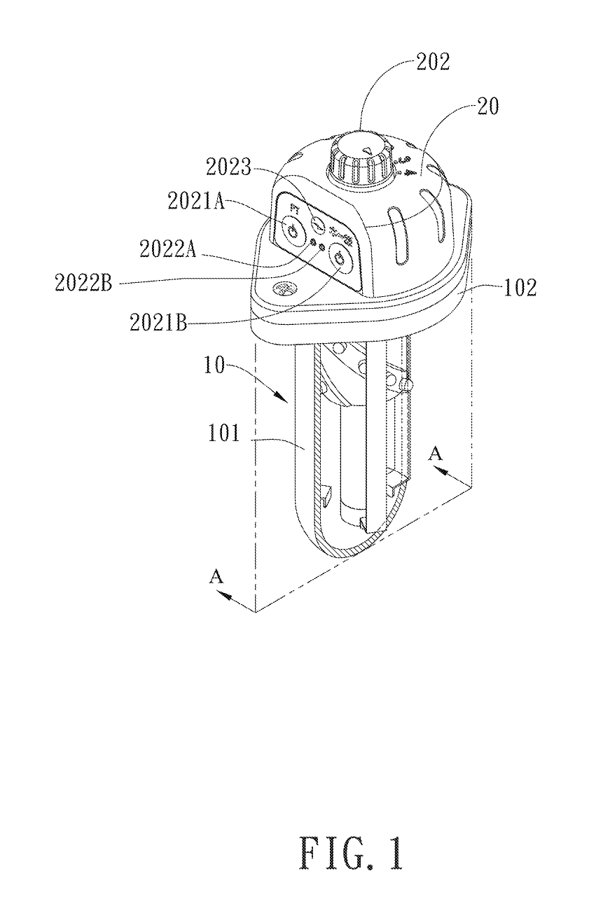

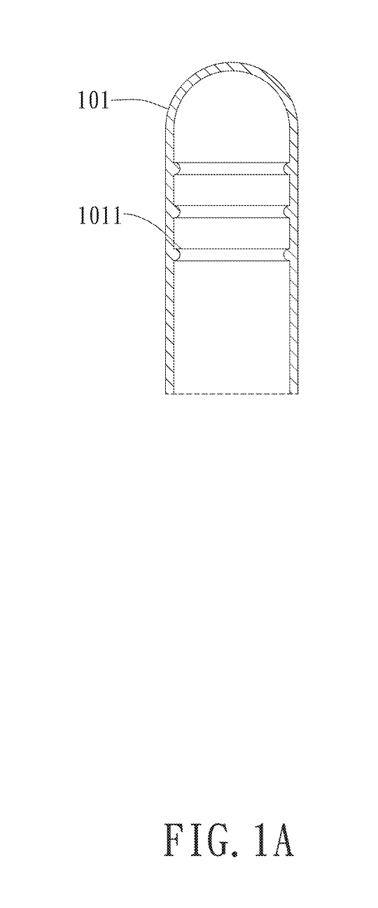

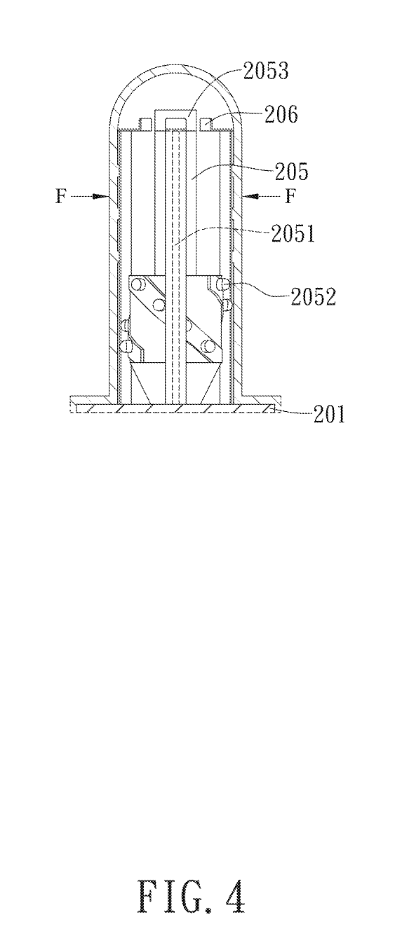

Referring to FIG. 1 and FIG. 4, which are a schematic appearance view and a perspective exploded view showing the feedback device capable of easily adjusting loaded force for sphincter contracting exercise (hereinafter referred as a feedback device 2) according to one preferred embodiment of the present invention. According to one preferred embodiment of the present invention, the feedback device 2 includes au outer enclosure 10 and an outer cover 20.

The outer enclosure 10 is made of a material having functions of waterproof and elasticity, and includes a sleeve 101 and a flange 102. The above-mentioned material can be silicon or other material having functions of waterproof and elasticity and not causing skin irritation. One end of the sleeve 101 is sealed, and the other end thereof is outwardly extended for forming as the flange 102. Referring to FIG. 1A, the inner wall of the sleeve 101 can be formed with patterns such as annular patterns 1011 or thread patterns (not shown in figures), thereby allowing the radial dimension of the sleeve 101 to be enlarged. As such, under a situation of the dimensions of other components of the feedback device 2 remaining to be the same, the whole dimension of the feedback device 2 is able to be altered through matching the outer enclosure 10 and the annular patterns 1011 having different dimensions, thereby being able to be used by users having various vagina sizes. The edge of the flange 102 is formed as a folded edge 1021, and one side of the folded edge 1021 is formed with a groove 1022.

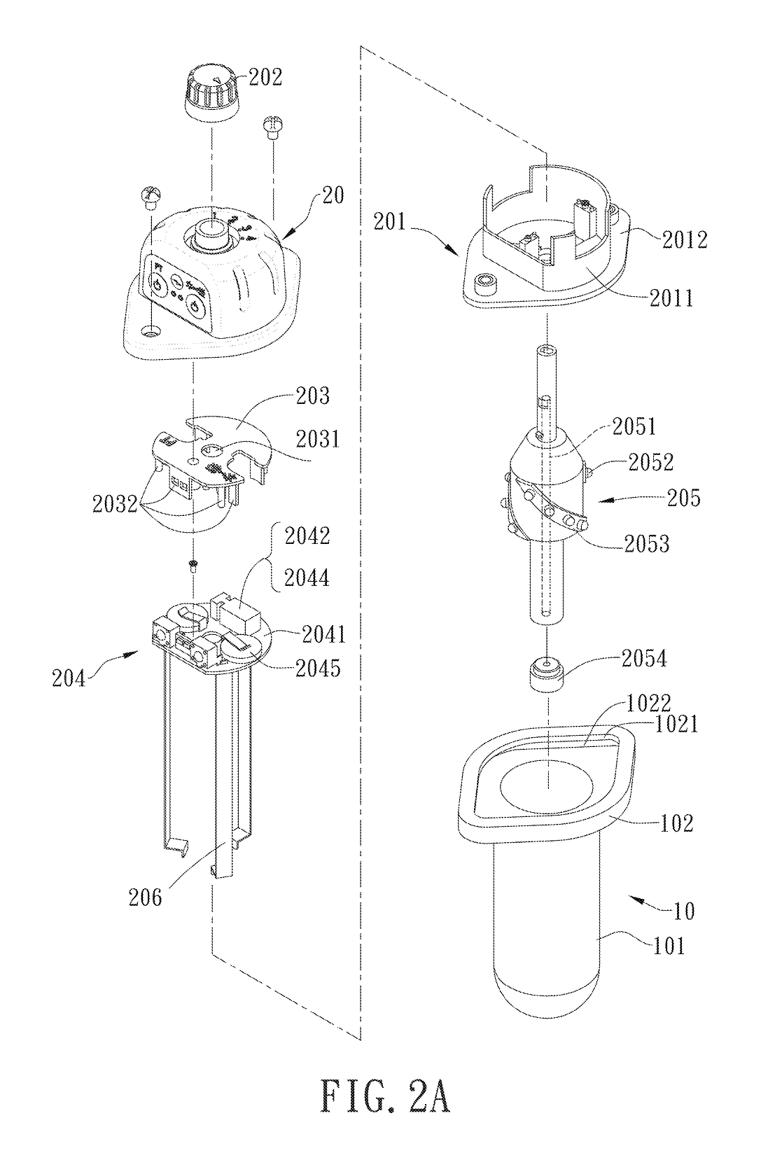

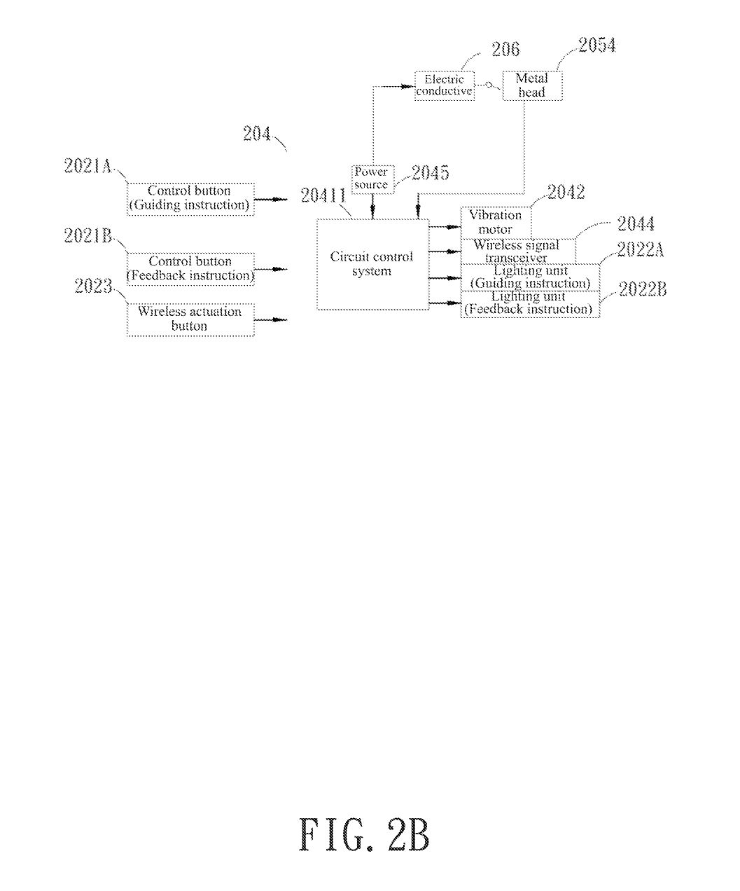

As shown in FIG. 1, one edge of the outer cover 20 is adjacent to the flange 102 of the outer enclosure 10 thereby forming the main appearance of the feedback device 2. Referring to FIG. 2A, which is a perspective exploded view, the edge of the outer cover 20 is connected to a base 201 with a locking means, and one side of the outer cover 20 is connected to a rotary button 202 with a rotary (or pivotal) means; the interior of the outer cover 20 is disposed with a shield plate 203 and a mechatronic assembly 204.

The base 201 is formed with a surround wall 2011 and a flange 2012. The surround wall 2011 is formed as being protruded into the outer cover 20 along the inner wall of the outer cover 20 so as to be in contact with the shield plate 203, thereby forming an accommodation space. The center and the periphery of the flange 2012 are formed with a plurality of holes (not provided with codes), the function of the holes will be illustrated thereinafter. The flange 2012 is able to be sleeved in the groove 1022 of the outer enclosure 10, so the outer enclosure 10 is adjacent to the outer cover 20 thereby forming a waterproof structure.

The center of the shield plate 203 is formed with a penetrated hole 2031, and one side of the shield plate 203 is formed with a plurality of position limiting blocks 2032 having different dimensions and different shapes.

Referring to FIG. 4 and FIG. 2A, the mechatronic assembly 204 includes a circuit control system 20411 installed on a circuit board 2041 (such as a printed circuit board) and including a calculator for processing signals and sending commands and a memory media for storing programs. In addition, the circuit system is connected to a vibration motor 2042 (such as an eccentric motor or other device capable of generating vibrations), a wireless signal transceiver 2044 and at least one power source 2045 (such as a battery). The above-mentioned vibration motor 2042, the wireless signal transceiver 2044 and the power source 2045 are clamped between the shield plate 203 and the circuit board 2041 and respectively positioned by the plural position limiting blocks 2032. The circuit control system 20411 is able to actuate or terminate (in other words whether generating vibrations) according to the signal of the vibration motor 2042 so as to selectively control the wireless signal transceiver 2044, the details will be illustrated thereinafter.

As shown in FIG. 4, the interior of the outer enclosure 10 and the outer cover 20 is provided with an electric conductive device. The electric conductive device includes a rotary central column 205 and a plurality of electric conductive sheets 206 surrounding the central column 205.

The central column 205 is formed with an axial channel 2051, and the middle section of the central column 205 is formed as an adjustment section having a relatively larger diameter, and the surface thereof is formed with a plurality of adjustment bumps 2052. The plural adjustment bumps 2052 are divided into several sets, each set of the bumps 2052 are arranged from the lowest to the highest with a certain means, for example according to one prefer embodiment of the present invention, the bumps 2052 are arranged with a means of surrounding the central column 205 and spaced with an equal horizontal angle with the central column 205 being served as an axle, so with a principle of the circumferential movement of 360 degrees, the horizontal angle between the bumps 2052 is smaller than 360°/(the quantity of bumps 2052-1), so whenever the central column 205 is rotated with a certain angle, the bumps 2052 are always able to be corresponding to the electric conductive sheets 206. Accordingly, the plural bumps 2052 are arranged to surround the surface of the adjustment section with a periodical manner, and the quantity of the bumps 2052 in each set is served to determine the adjustment stages of the feedback device 2. Moreover, the dimension of each of the bumps 2052 can be the same or different, and the protruding level of the bumps 2052 can be altered according to the actual needs. What shall be addressed is that each set of the bumps 2052 can be connected in series by a slide rail 2053, the slide rail 2053 is protruded from the surface of the central column 205 but the protruding level is smaller than the bumps 2052. Furthermore, one end of the central column 205 is protruded into the central hole of the base 201 and the shield plate 203, and passed the outer cover 20 for being connected to the rotary button 202. As such, the central column 205 is able to be rotated or pivotally moved through rotating or pivotally moving the rotary button 202. Another end of the central column 205 is connected to a metal head 2054 (as such copper or other electric conductive alloy), and the metal head 2054 utilizes a wire passing the channel 2051 for being connected to the mechatronic assembly 204.

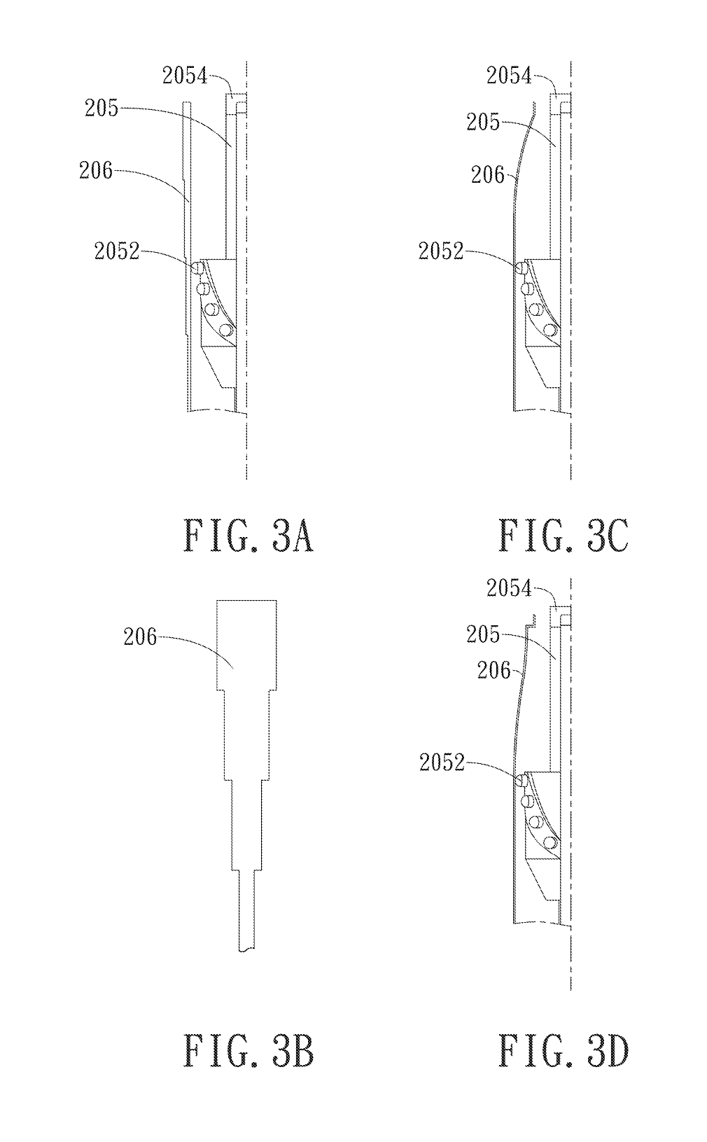

One end of each of the plural electric conductive sheets 206 is passed the hole formed on the base 201 and fastened on the circuit board 2041 so as to be connected to the mechatronic assembly 204, and the other end thereof is extended to the ambience of the metal head 2054, thereby forming a bending status with certain angle, what shall be addressed is that the electric conductive sheets 206 are not in contact with the metal head 2054. The material of which the electric conductive sheets 206 are made can be copper, silver or other alloy having great electric conductivity and compressive strength. Regarding to the hardness design, the whole thickness of each of the electric conductive sheets 206 can be the same or different, and the area of the force loading surface and/or the contacting surface can be adjusted according to the actual needs, as shown in FIG. 3A and FIG. 3B. In addition, referring to FIG. 3C and FIG. 3D, the electric conductive sheets 206 being in two different bending statuses is provided. What shall be addressed is that the shape of the adjustment section of the central column 205 and the dimension of the bumps 2052 can be altered with respect to the shape of the electric conductive sheet 206.

The quantity of the electric conductive sheets 206 is the same as the set numbers of the bumps 2052, and each of the electric conductive sheets 206 is able to utilize the bump 2052 as a pivot for performing a lever movement, the details will be illustrated thereinafter.

Under the situation of the plural electric conductive sheets 206 not being in contact with the metal head 2054, the plural electric conductive sheets 206, the vibration motor 2042, the power source 2045 and the metal head 2054 form a vibration motor system which is break in the normal status; when the free end of at least one of the electric conductive sheets 206 is in contact with the metal head 2054, the vibration motor system is conducted for allowing the vibration motor 2042 to be actuated.

Referring to FIG. 4, which is a longitudinal cross sectional view showing the feedback device 2. The adjustment section of the central column 205 and the metal head 2054 are stably disposed in the outer enclosure 10, and the electric conductive sheet 206 is extended along the inner wall of the outer enclosure 10 to the top of the outer enclosure 10, and the length of the electric conductive sheet 206 is preferably to be formed as the free end thereof being able to be easily in contact with the metal head 2054. The arrow F is served to represent the external force applied on the outer enclosure 10, when the outer enclosure 10 is pressed, the electric conductive sheets 206 are pressed thereby enabling the electric conductive sheet 206 to perform the lever movement having the bump 2052 served as the pivot so as to be in a bending status.

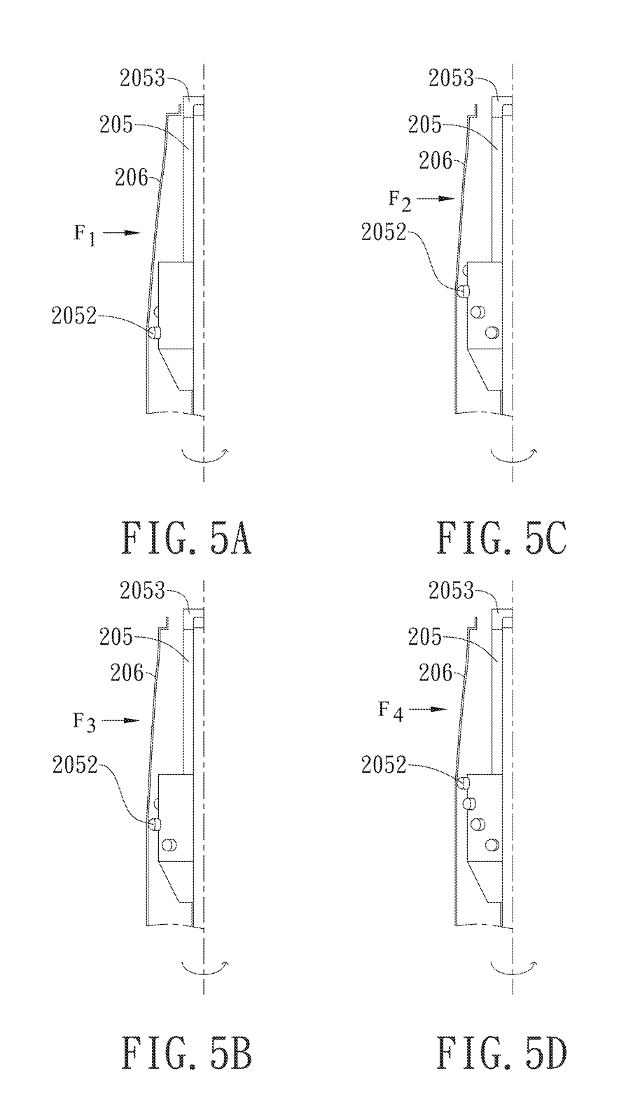

Referring from FIG. 5A to FIG. 5D, the location of the pivot is able to allow the bump 2052 to be selectively moved to a location corresponding to the electric conductive sheet 206 through adjusting the central column 205. As what has been disclosed above, the quantity of the bumps 2052 in each set defines the adjustment stages. According to this embodiment, each set of the bumps 2052 has four different locations, so each of the electric conductive sheets 206 is able to be corresponding to the bumps 2052 (served as the pivot) at the four different locations. Because of different pivot, the external force for enabling the electric conductive sheet 206 to be in contact with the metal head 2054 is different (in other words F₄>F₃>F₂>F₁). The closer the bump 2052 (served as the pivot) to the free end of the electric conductive sheet 206, the greater external force is required (in other words the exercise impedance of the feedback device 2 is greater). In addition, when the central column 205 is rotated, the slide rail 2053 on the surface of the central column 205 is able to prevent the electric conductive sheets 206 from being interfering with the bumps 2052 during the rotation, so the rotation of the central column 205 can be ensured to be smooth. In other words, when the central column 205 is rotated, the slide rail 2053 is able to guide the electric conductive sheet 206 in the undesired location to be back to the desired location, thereby preventing from being interfering with the bump 2052.

As such, after the outer enclosure 10 of the feedback device 2 is inserted into a vagina, the user is able to selectively adjust the rotary button 202 for switching the exercise impedance. When the contraction force of the sphincter around the vagina is sufficient enough for overcoming the impedance, the electric conductive sheet 206 is pressed for being in contact with the metal head 2054 so as to allow the motor to be actuated, thereby providing a sensational feedback to the user.

Referring to FIG. 1, in the feedback device 2 provided by the present invention, the surface defined at one side of the outer cover 20 is installed with at least two control buttons 2021A, 2021B and at least two lighting units 2022A, 2022B, the above four are divided into two sets which are one guiding set (2021A, 2022A) and a switching set (2021B, 2022B) connected to the circuit control system 20411. The user can press the control button 2021A for at least one time to actuate the lighting unit 2022A, and the flashing light of the lighting unit 2022A can be served to guide the user for exercise. The user can press the control button 2021B for at least one time to switch the feedback mode of the feedback device 2, for example the feedback device 2 can be switched to the motor vibration mode, or switched for allowing the lighting unit 2022B to provide flashing lights so as to allow the user to be informed with the exercise correctness. Moreover, a wireless actuation button 2023 is provided, when the wireless actuation button 2023 is pressed, the wireless signal transceiver 2044 is actuated for being connected to other corresponding devices outside the feedback device 2 with a wireless means, the details will be illustrated thereinafter.

An application of the present invention is provided as following. The feedback device 2 of the present invention is able to work with certain application software installed in a computing device. The above-mentioned computing device can be a mobile phone, a tablet computer or a computing device having a wireless transferring function. The above-mentioned wireless transferring means can be achieved through adopting a Bluetooth or WiFi. The user can switch the feedback device 2 to a computing device connection mode for allowing the user to perform the Kegel exercise. According to this embodiment, when switching to the connection mode, the feedback device 2 is able to communicate with the computing device through the wireless signal transceiver and allow the corresponding application software to be automatically opened; or the corresponding application software has to be opened, then the feedback device 2 is switched to the connection mode for being communicated with the computing device. During the Kegel exercise, when the electric conductive sheet 206 is in contact with the metal head 2054, the feedback device 2 is enabled to transfer feedback signals to the computing device, so the feedback signals can be timely shown to the user through the corresponding application software.

Moreover, the application software is able to utilize a display and/or a speaker installed in the computing device, so an instruction/command is able to be provided through displaying images and/or transmitting sounds for allowing the user perform exercise such as muscle training, muscle endurance training and reaction training. The application software is able to record, manage and/or edit the training result for providing a reference to the medical treatment or rehabilitation. The application software can be designed as a game with entertaining effect for encouraging the user to perform the Kegel exercise. Comparing to the conventional sphincter training device which only records the operating status (such as force applying data) of single user, the feedback device 2 of the present invention is able to provide the user the information of whether the user correctly performing the exercise through lighting and vibrations (in other words the feedback device 2 working with the training program set in the feedback device 2).

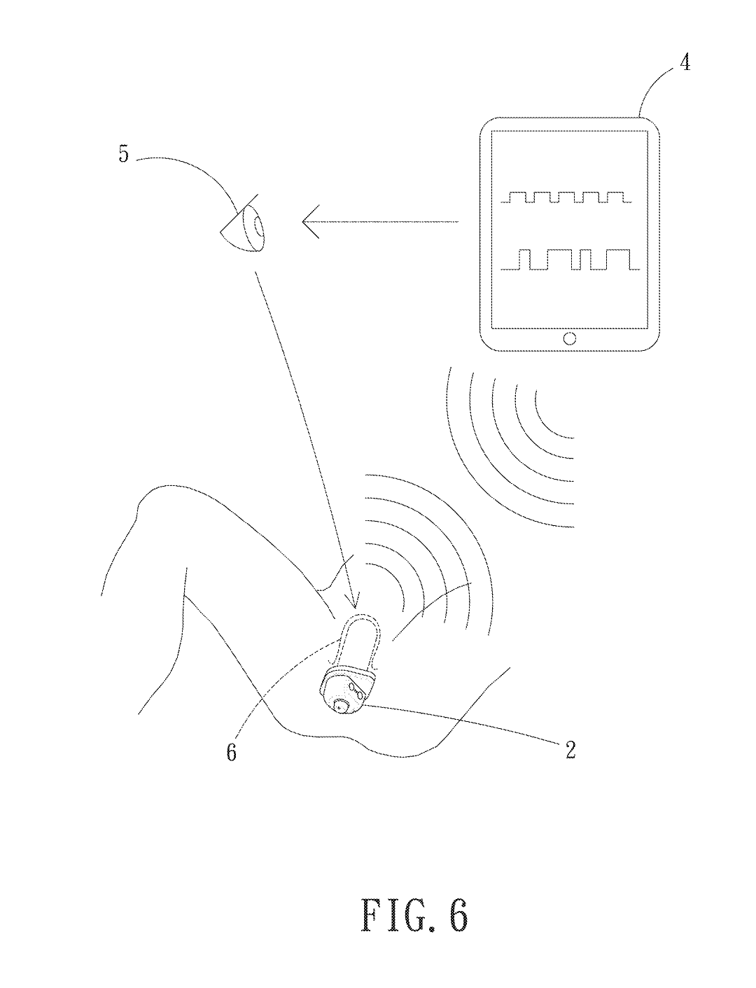

Referring to FIG. 6, which shows the interaction between the user and the computing device. When the tablet computer is connected to the feedback device 2, the user is able to receive the audio and/or video instruction sent by the tablet computer 4 (for example the instruction being received by eyes 5), so the user can control the sphincter around the vagina 6 to contract with respect to the instruction, the correctness of sphincter exercise can be provided through the vibrations or lighting of the feedback device 2, or be provided through the videos shown in the tablet computer 4. As such, the application software corresponding to the feedback device 2 can be designed as a game, the feedback device 2 can be served as a controller of the game, and the body portion to be controlled is the sphincter; the game can also be designed to have a beginner, a middle and a professional level with respect to the training strength, and each level can be designed to have various training means. As such, the user can perform the Kegel exercise just like playing a game.

The feature of the feedback device 2 provided by the present invention is to allow the training impedance value of the feedback device 2 to be altered through rotating and adjusting the electric conductive device, so when the user performs the sphincter contracting exercise, the foundation value of the sphincter contracting strength can be easily set for providing a gradual training effect, and the progress of the muscle strength and the muscle endurance of the sphincter can be correctly provided.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A feedback device capable of easily adjusting loaded force for sphincter contracting exercise, including:
an outer enclosure, made of an elastic material;
an outer cover, stably connected to the outer enclosure so as to form an accommodation space;
a mechatronic assembly, disposed in the accommodation space defined by the outer enclosure and the outer cover; and
an electric conductive device, including:
a plurality of electric conductive sheets, one end of each of the electric conductive sheets being electrically connected to the mechatronic assembly and the other end thereof being extended into the interior of the outer enclosure; and
a central column, having one end connected to the mechatronic assembly with a rotary means and the other end extended into the interior of the outer enclosure and electrically connected to the mechatronic assembly, the outer surface of the central column being formed with a plurality of bumps, and the locations of the plural bumps being able to be altered when the central column being rotated;
wherein, the plural electric conductive sheets being able to respectively perform a lever movement with the bumps served as a pivot thereby being selectively in contact with the other end of the central column for actuating or stopping the mechatronic assembly; the interior of the outer enclosure being formed with patterns having a certain thickness; the plural bumps being arranged to surround the surface of the central column with a periodical manner; the other end of the central column extended into the interior of the outer enclosure being formed as a metal head, and the metal head utilizing a wire for being electrically connected to the mechatronic assembly; and the mechatronic assembly being conducted through the metal head being in contact with any of the electric conductive sheets.

2. The feedback device capable of easily adjusting loaded force for sphincter contracting exercise as claimed in claim 1, wherein the outer cover is installed with a rotary button for providing an adjustment function, and the rotary button is connected to one end of the central column.

3. The feedback device capable of easily adjusting loaded force for sphincter contracting exercise as claimed in claim 1, wherein the mechatronic assembly includes a vibration motor, two lighting units and a wireless signal transceiver.

4. The feedback device capable of easily adjusting loaded force for sphincter contracting exercise as claimed in claim 1, wherein the surface of the central column is provided with a slide rail protruded from the surface of the central column.

5. The feedback device capable of easily adjusting loaded force for sphincter contracting exercise as claimed in claim 1, wherein the width of each of the electric conductive sheets is gradually increased from one end towards the free end, and the thickness of each of the electric conductive sheets is gradually increased from one end towards the free end.
